(19) United States
(12) Patent Application Publication
(10) Pub. No.: US 2012/0306443 A1
(43) Pub. Date: Dec. 6, 2012

(54) AUTOMATED CHARGING FOR VEHICLE ENERGY STORAGE SYSTEMS

(75) Inventors: Anthony L. SMITH, Troy, MI (US); Dalong GAO, Rochester, MI (US); Vincent M. CONFORTI, Clarkston, MI (US); Roland J. Menassa, Macomb, MI (US)

(73) Assignee: GM GLOBAL TECHNOLOGY OPERATIONS LLC, DETROIT, MI (US)

(21) Appl. No.: 13/153,321

(22) Filed: Jun. 3, 2011

(51) Int. Cl. H02J 7/00

(52) U.S. Cl. 320/109

(57) ABSTRACT

Methods and systems are provided for charging an energy storage system of a vehicle. A processor is coupled to an arm. The processor is configured to obtain a position of the vehicle. The processor is further configured to guide the arm to locate a charging receptacle of the vehicle based on the position and to insert the charging device into the charging receptacle.

### TECHNICAL FIELD

The technical field generally relates to the field of vehicles and, more specifically, to methods and systems for automated charging of energy storage systems for vehicles.

### BACKGROUND

Various types of automobiles, such as electric vehicles and hybrid electric vehicles, have an energy storage system that requires charging. Typically, such an energy storage system is manually connected to a power source, for example, by a driver of the vehicle. However, such manual charging of the energy storage system may not always be optimal, for example if the driver may forget to charge the energy storage system, and/or if the driver would be inconvenienced by this task.

Accordingly, it is desirable to provide improved methods for charging vehicle energy storage systems using an automated device. It is also desirable to provide improved program products and automated systems for charging vehicle energy storage systems. Furthermore, other desirable features and characteristics will be apparent from the subsequent detailed description and the appended claims, taken in conjunction with the accompanying drawings and the foregoing technical field and background.

### SUMMARY

In accordance with an exemplary embodiment, a method is provided for charging an energy storage system of a vehicle. The method comprises the steps of obtaining a position of the vehicle, locating a charging receptacle of the vehicle based on the position, and guiding an arm to insert a charging device into the charging receptacle via a processor.

In accordance with another exemplary embodiment, a program product is provided for charging an energy storage system of a vehicle. The program product comprises a program and a non-transitory, computer-readable storage medium. The program is configured to obtain a position of the vehicle, locate a charging receptacle of the vehicle based on the position, and guide an arm to insert a charging device into the charging receptacle. The non-transitory, computer-readable storage medium stores the program.

In accordance with a further exemplary embodiment, an automated system is provided for charging an energy storage system of a vehicle. The automated system comprises an arm and a processor. The processor is coupled to the arm. The processor is configured to obtain a position of the vehicle, and to guide the arm to locate a charging receptacle of the vehicle based on the position and insert the charging device into the charging receptacle.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of an automated system for automatically charging an energy storage system of a vehicle, such as an electric or hybrid electric automobile, in accordance with an exemplary embodiment;

FIG. 2 is a flowchart of a process for automatically charging an energy storage system of a vehicle, such as an electric or hybrid electric automobile, and that can be utilized in connection with the automated system of FIG. 1, in accordance with an exemplary embodiment;

FIG. 3 is a flowchart of a sub-process of the process of FIG. 2, namely, the sub-process of opening a door of a charging receptacle of the vehicle, in accordance with an exemplary embodiment;

FIG. 4 is a flowchart of a sub-process of the process of FIG. 2, namely, the sub-process of inserting a charging plug into the charging receptacle, in accordance with an exemplary embodiment;

FIG. 5 is a flowchart of a sub-process of the process of FIG. 2, namely, the sub-process of removing the charging plug from the charging receptacle, in accordance with an exemplary embodiment;

FIG. 6 is a flowchart of a sub-process of the process of FIG. 2, namely, the sub-process of closing the door of the charging receptacle, in accordance with an exemplary embodiment; and

FIG. 7 is a flowchart of a process for moving an automated device used for charging an energy storage system of a vehicle, such as an electric or hybrid electric automobile, and that can be utilized in connection with the automated system of FIG. 1, the process of FIG. 2, and various of the sub-processes of FIGS. 2-6, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

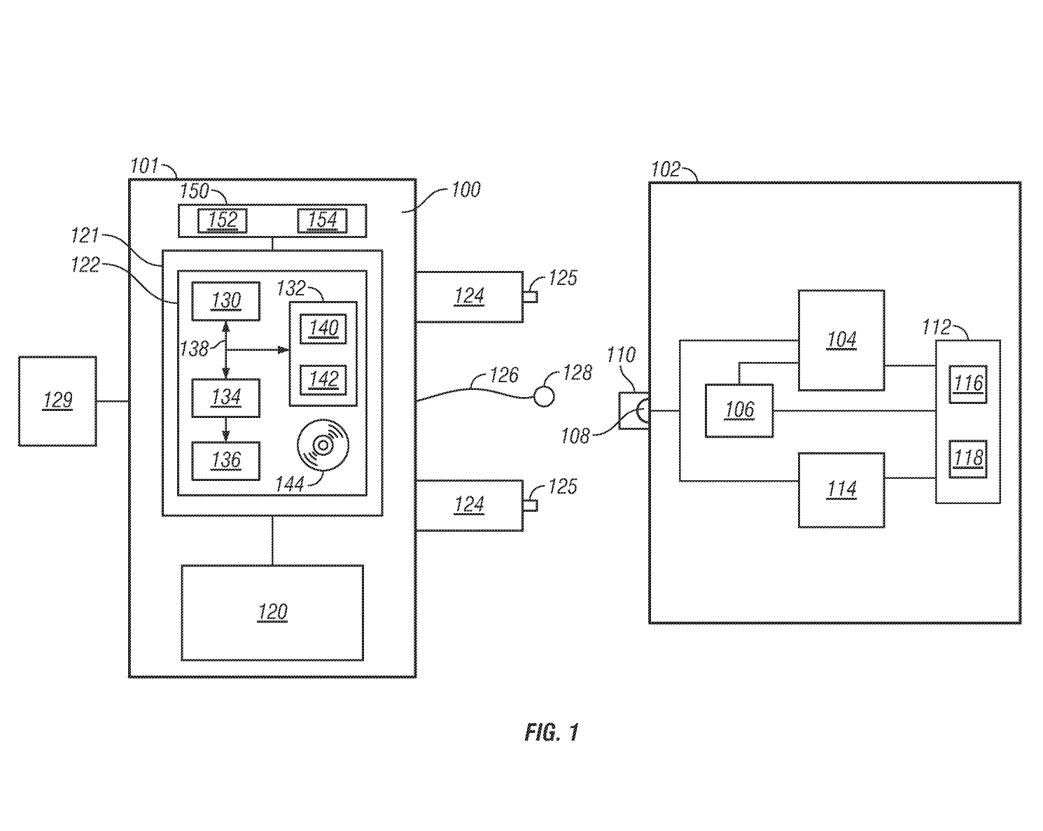

FIG. 1 is a functional block diagram of an automated system 100 for automatically charging an energy storage system 104 of a vehicle 102, in accordance with an exemplary embodiment. In certain embodiments, the vehicle 102 comprises an automobile, such as a sedan, a sport utility vehicle, a van, or a truck. However, the automated system 100 may also be used with various other types of vehicles. In one preferred embodiment, the vehicle 102 comprises an electric vehicle. In another preferred embodiment, the vehicle 102 comprises a hybrid electric vehicle.

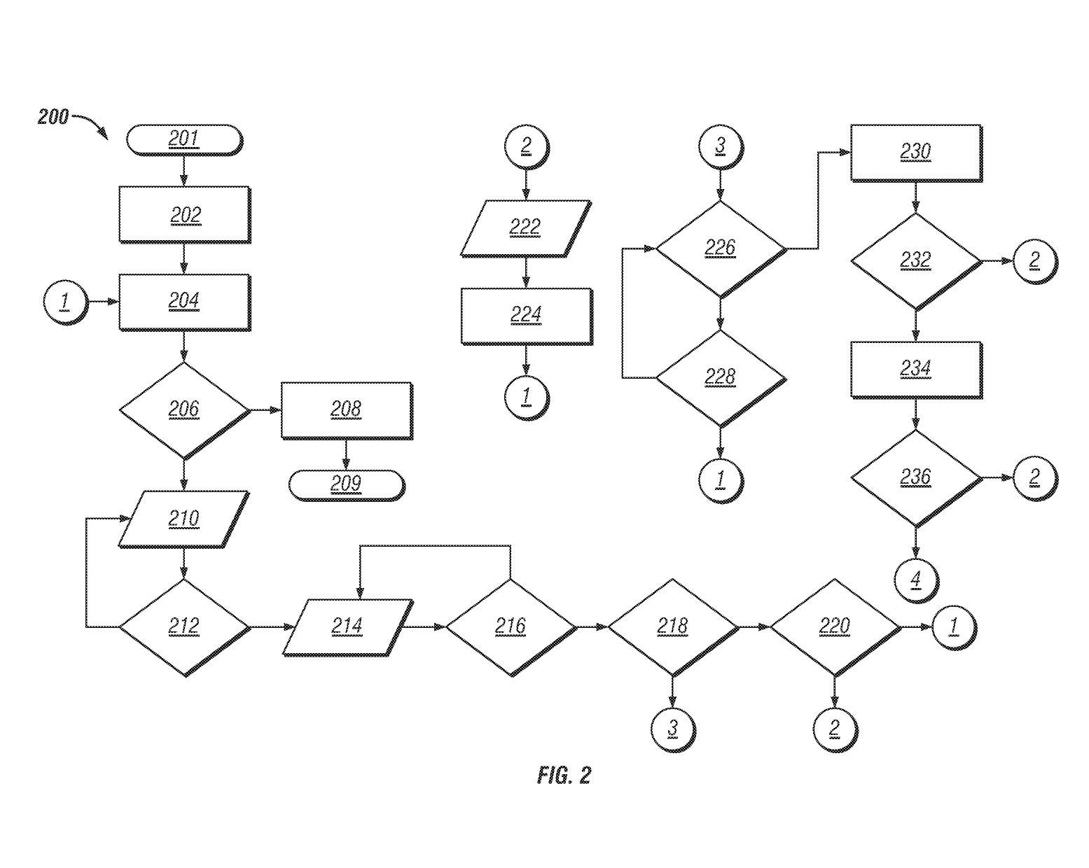

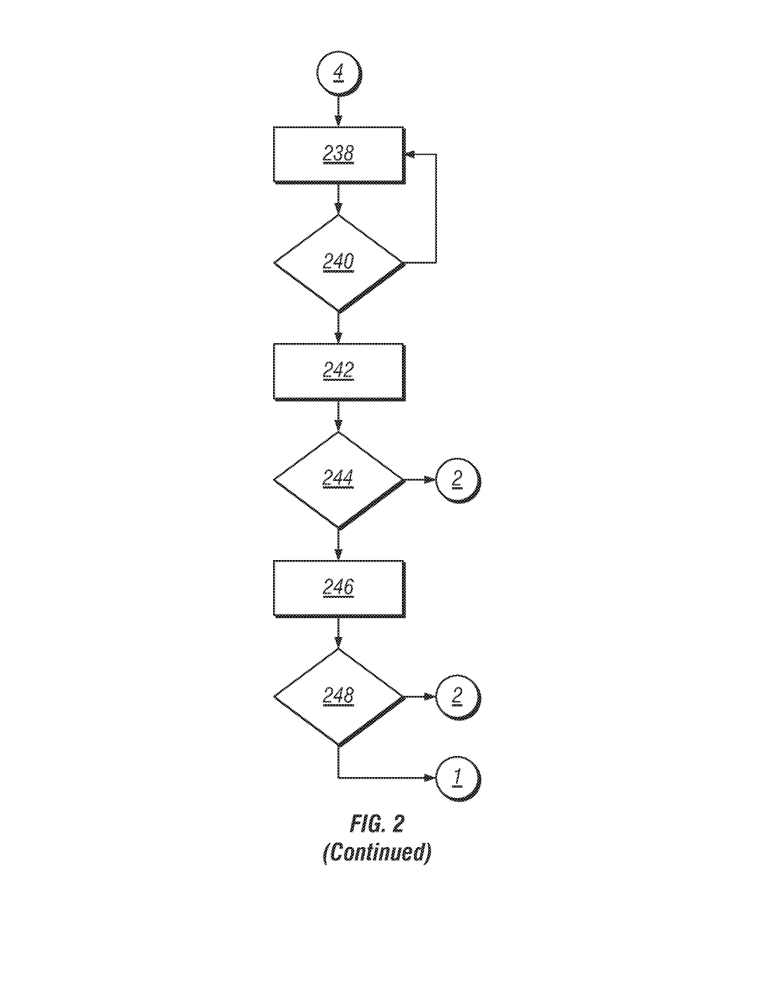

In the depicted embodiment the vehicle 102 includes, in addition to the energy storage system 104, a motor 106, a charging receptacle 108, a receptacle door 110, a controller 112, and a communication device 114. In certain embodiments, the receptacle door 110 may not be necessary, and corresponding features pertaining to the receptacle door 100 described herein (such as in connection with the processes 200, 700 and/or sub-processes thereof of FIGS. 2-7 may likewise not be necessary). The energy storage system 104 preferably comprises a battery, such as a high voltage battery. The energy storage system 104 is preferably coupled to the motor 106. The energy storage system 104 is configured to power the motor 106, at least in certain modes (for example, in a battery/electric operating mode). The energy storage system 104 is coupled to the charging receptacle 108 for charging the energy storage system 104. The charging receptacle 108 is enclosed by a receptacle door 110, and is accessible from outside the vehicle 102 via the receptacle door 110.

The controller 112 is coupled to the energy storage system 104, the motor 106, and the communication device 114. The controller 112 controls operation of the energy storage system 104 and the motor 106. In addition, the controller 112 determines when the energy storage system 104 requires charging, and when a charging procedure should be completed. The controller 112 communicates this and other information to the automated system 100 via the communication device 114. In one embodiment, the communication device 114 comprises a communication bus for the vehicle 102, and can be accessed by the automated system 100, for example by connecting to the communication bus. In another embodiment, the communication device 114 includes a transmitter for providing this and/or other information to the automated system 100, such as via a wireless network.

In one embodiment, the controller 112 comprises a computer system with a processor 116, a memory 118, and/or various other computer system components similar to those described below in connection with the computer system 122 of the automated system 100. The processor 116 of the controller 112 preferably performs the various functions of the controller 112 in accordance with certain steps of the processes 200, 700 described further below in connection with FIGS. 2-7.

The automated system 100 (also referred to herein as an automated device) is configured to be coupled to the vehicle 102. The automated system 100 is disposed external to the vehicle. In one embodiment, the automated system 100 is disposed in or in close proximity to a garage, a parking lot, and/or another location in which the vehicle 102 is located while the vehicle is not being driven (for example, in between vehicle drives and/or ignition cycles). In one preferred embodiment, the automated system 100 comprises a robot, with each of its component parts disposed within or attached to a housing 101 of the robot.

As depicted in FIG. 1, the automated system 100 comprises one or more sensors 120, a control unit 121, one or more arms 124, a charging cord 126, a charging plug 128, and one or more indicators 150. The automated system 100 is coupled to an electric power source 129. The automated system 100 is configured to charge the energy storage system 104 of the vehicle 102 using electrical energy from the electric power source 129.

The sensors 120 are used to detect and/or measure values pertaining to the vehicle 102. Specifically, the sensors 120 are configured to detect movement of the vehicle 102, and to obtain measurements as to a position of the vehicle 102. The sensors 120 are also configured to detect obstacles that may be in a trajectory or path between the automated system 100 and the vehicle 102. The sensors 120 provide signals representative of such detections, measurements, and/or values, and/or information thereto, to the control unit 121 for processing, for example for use in determining whether the vehicle 102 is in an appropriate position for charging and in determining whether any obstacles need to be avoided as the automated system 100 and/or components thereof move toward the vehicle 102.

The arms 124 are used to locate and open the receptacle door 110 of the vehicle 102. In addition, the arms 124 are used to move the charging cord 126 toward the vehicle 102, insert the charging plug 128 into the charging receptacle 108 of the vehicle when charging is needed, and remove the charging plug 128 from the charging receptacle 108 when charging is complete and/or is no longer needed or desired. The arms 124 are controlled via instructions provided by the control unit 121. While two arms 124 are depicted in FIG. 1, the number of arms 124 may vary. For example, in certain embodiments, the automated system 100 may include a single arm 124. By way of further example, in certain other embodiments, the automated system 100 may include three or more arms 124. Each arm 124 has one or more effectors 125 that are directed by the control unit 121 and utilized to open and close the receptacle door 110 and connect and disconnect the charging plug 128 into and from the charging receptacle 108.

The control unit 121 is coupled to the sensors 120 and the arms 124 of the automated system 100. The control unit 121 receives signals and information from the sensors 120 (for use in determining when the vehicle 102 is nearby and whether objects are in a path or trajectory toward the vehicle 102) as well as from the vehicle 102 (including information as to whether the energy storage system 104 requires charging, and when such charging is no longer required). The control unit 121 processes this information for use in controlling the arms 124 and the effectors 125 and for charging the energy storage system 104 of the vehicle 102.

The control unit 121 directs the arms 124 and effectors 125 toward the vehicle 102, and utilizes the arms 124 and effectors 125 for opening the receptacle door 110 and inserting the charging plug 128 into the charging receptacle 108 in order to charge the energy storage system 104 of the vehicle 102 when charging is required. The control unit 121 similarly directs the arms 124 and effectors 125 to remove the charging plug 128 from the charging receptacle and close the receptacle door 110 after charging is no longer required. The control unit 121 preferably performs these and other functions in accordance with the steps of the processes 200, 700 (and the various sub-processes thereof) described further below in connection with FIGS. 2-7.

The control unit 121 may communicate with the vehicle 102 (preferably, the controller 112 thereof) in any one or more of a number of different manners. In certain embodiments, the control unit 121 includes or is coupled to a receiver (not depicted) for receiving communications from the controller 112. In certain other embodiments, the control unit 121 receives communications from the controller 112 via a physical coupling to the vehicle, such as via physical contact between one or more of the arms 124 and/or the charging cord 126 with the vehicle 102. In still other embodiments, the control unit 121 communicates with the controller 112 via a computer interface, such as the interface 134 described further below, and/or via a wireless network. In certain embodiments, the automated system 100 may also obtain vehicle information by detecting a vehicle presence via one or more sensors, cameras, proximity sensors, or the like.

In certain embodiments, the control unit 121 is also coupled to one or more indicators 150. The indicators preferably include one or more audio indicators 152 (such as a means for providing verbal commands) and one or more visual indicators 154 (such as flashing lights). The control unit 121 provides instructions to the indicators 150 to provide notifications for a driver of the vehicle 102 as to proper placement of the vehicle 102 with respect to the automated system 100 for charging of the energy storage system 104, and as to any possible problems or other issues with the charging of the energy storage system 104 or with the automated system 100. In addition, the indicators 150 provide notice of any obstacles that are in a projected path or trajectory of the automated system 100.

As depicted in FIG. 1, the control unit 121 comprises a computer system 122. In certain embodiments, the control unit 121 may also include one or more of the sensors 120, arms 124, and/or one or more other components. In addition, it will be appreciated that the control unit 121 may otherwise differ from the embodiment depicted in FIG. 1, for example in that the control unit 121 may be coupled to or may otherwise utilize one or more remote computer systems and/or other control systems.

The computer system 122 includes a processor 130, a memory 132, an interface 134, a storage device 136, and a bus 138. The processor 130 performs the computation and control functions of the computer system 122 and the control unit 121, and may comprise any type of processor or multiple processors, single integrated circuits such as a microprocessor, or any suitable number of integrated circuit devices and/or circuit boards working in cooperation to accomplish the functions of a processing unit. During operation, the processor 130 executes one or more programs 140 contained within the memory 132 and, as such, controls the general operation of the control unit 121 and the computer system 122, preferably in executing the steps of the processes 200, 700 described further below in connection with FIGS. 2-7.

The memory 132 can be any type of suitable memory, including, for example, various types of dynamic random access memory (DRAM) such as SDRAM, the various types of static RAM (SRAM), and the various types of non-volatile memory (PROM, EPROM, and flash). The bus 138 serves to transmit programs, data, status and other information or signals between the various components of the computer system 122. In a preferred embodiment, the memory 132 stores the program 140 along with one or more stored values 142 used by the processor 130. In certain examples, the memory 132 is located on and/or co-located on the same computer chip as the processor 130.

The interface 134 allows communication for the computer system 122, for example with the controller 112 and/or with a system driver and/or another computer system, and can be implemented using any suitable method and apparatus. It can include one or more network interfaces to communicate with other systems or components. The interface 134 may also include one or more network interfaces to communicate with technicians and/or the power company, and/or one or more storage interfaces to connect to storage apparatuses, such as the storage device 136.

The storage device 136 can be any suitable type of storage apparatus, including direct access storage devices such as hard disk drives, flash systems, floppy disk drives and optical disk drives. In one exemplary embodiment, the storage device 136 comprises a program product from which memory 132 can receive a program 140 that executes one or more embodiments of one or more processes of the present disclosure, such as the steps of the processes 200, 700 described further below in connection with FIGS. 2-7. In another exemplary embodiment, the program product may be directly stored in and/or otherwise accessed by the memory 132 and/or a disk (e.g. disk 144), such as that referenced below.

The bus 138 can be any suitable physical or logical means of connecting computer systems and components. This includes, but is not limited to, direct hard-wired connections, fiber optics, infrared and wireless bus technologies. During operation, the program 140 is stored in the memory 132 and executed by the processor 130.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 130) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system 122 may also otherwise differ from the embodiment depicted in FIG. 1, for example in that the computer system 122 may be coupled to or may otherwise utilize one or more remote computer systems and/or other control systems.

FIGS. 2-7 are flowcharts of a process 200 for automatically charging an energy storage system of a vehicle, such as an electric or hybrid electric automobile, in accordance with an exemplary embodiment. The process 200 can be utilized by the automated system 100 of FIG. 1 for automated charging of the energy storage system 104 of the vehicle 102 of FIG. 1.

As depicted in FIG. 2, the process 200 begins once an automated device is turned on or activated (step 201). The automated device preferably corresponds to the automated system 100 of FIG. 1. Specifically, an initialization procedure is performed (step 202) after the automated system 100 of FIG. 1 is first turned on or activated in step 201. The initialization procedure preferably includes a system power-up as well as a self-test for the automated system 100 of FIG. 1. In certain embodiments, the initialization procedure includes checks as to whether various components of the automated system 100 (for example, the sensors 120, the arms 124, and the effectors 125 of FIG. 1) are operational. The initialization procedure is preferably performed by the processor 130 of the automated system 100 of FIG. 1.

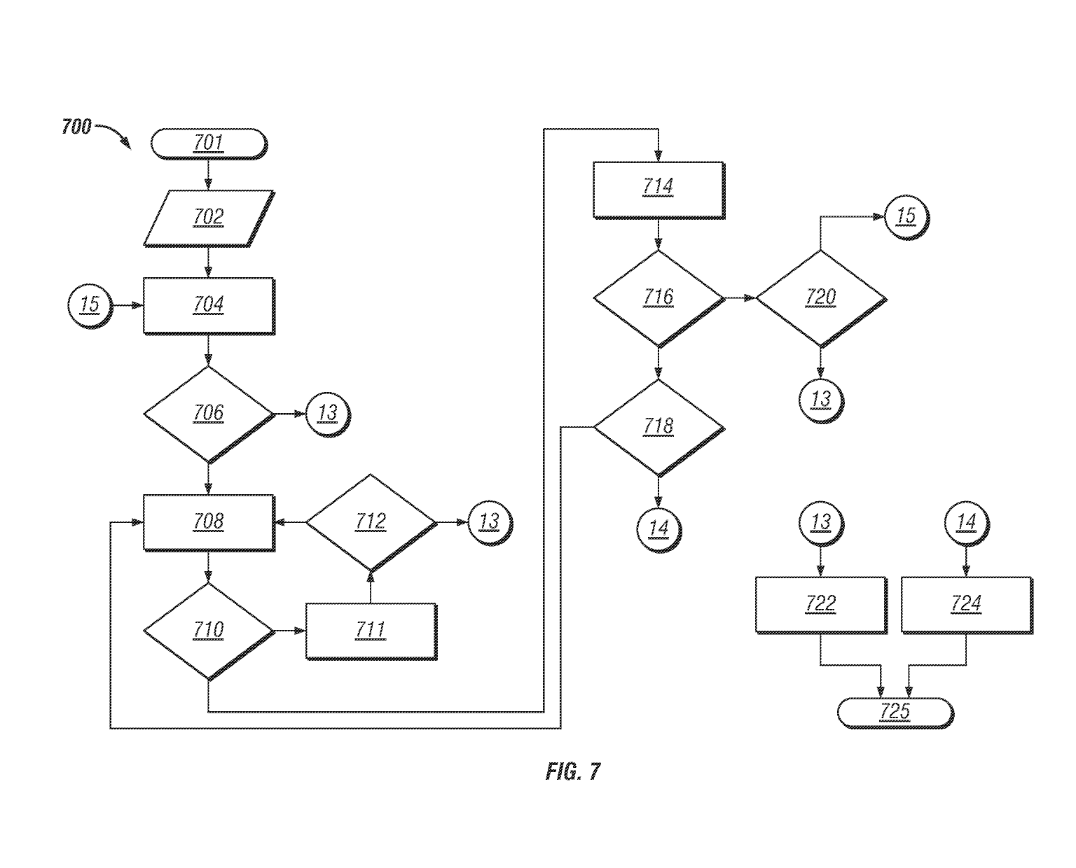

Once the initialization procedure is complete, the automated device is moved to its standby position (step 204). Once in the standby position, the automated device is ready to perform its functions, for example by determining when a new vehicle approaches, determining if such vehicle requires a charge for its energy storage system, and charging the energy storage system of the vehicle. The movement of the automated device is preferably directed by the processor 130 of FIG. 1. When the automated device moves, such as in step 204 (as well as in certain other steps described further below), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 204 (as well as certain other steps described further below that also pertain to movement of the automated device) comply with the steps of the process 700 that are depicted in FIG. 7 and described in greater detail further below in connection therewith.

A determination is made as to whether the automated device is being shutdown (step 206). For example, the automated device may be in the process of being shut down if the automated device is disconnected from a power source (such as the electric power source 129 of FIG. 1), or if the automated device is turned off by a user. The determination of step 206 is preferably made by the processor 130 of FIG. 1.

If it is determined in step 206 that the automated device is being shut down, then the automated device performs a shutdown procedure (step 208). The shutdown procedure preferably includes storage of any data that may be used the next time that the automated device is started up again. The shutdown procedure may also include various diagnostic tests as to whether the automated device and/or certain components thereof (such as the sensors 120 and/or the arms 124) are operating properly. The shutdown procedure is preferably performed by the processor 130 of FIG. 1. The process 200 then exits (step 209), until such time as the automated device is turned on or activated again during a subsequent iteration of step 201.

Conversely, if it is determined in step 206 that the automated device is not being shut down, then a position of the vehicle is obtained (step 210). In one embodiment, the position of the vehicle is obtained based on a detected movement of a vehicle that is in proximity to the automated device. However, this may vary in other embodiments. For example, in certain embodiments, the position of the vehicle may be based on static information of the vehicle. For example, a camera/proximity sensor may be utilized to detect that the vehicle is disposed at a certain position. It can subsequently be detected if the vehicle is not present at a later time. Accordingly, if the vehicle is returned and parked again at the same location, the vehicle may still be distinguished from a vehicle that was not moved. The vehicle preferably corresponds to the vehicle 102 of FIG. 1. In one embodiment, one or more of the sensors 120 of FIG. 1 detect when the vehicle 102 of FIG. 1 (which may be an existing vehicle that was already in proximity to the automated device and is being repositioned, or may be a new vehicle that has just arrived in proximity to the automated device), and provide signals pertaining to the movement and/or information related thereto to the processor 130 of FIG. 1, and the processor 130 determines the position of the vehicle based on this information received from the sensors 120.

A determination is then made as to whether the vehicle is in proximity to the automated device (step 212). Preferably, in one embodiment, during step 212, the determination is made as to whether the vehicle is in range of the automated device. The determination of step 212 is preferably made by the processor 130 of FIG. 1 using the information obtained from the sensors 120 of FIG. 1 and the processing thereof by the processor 130 of FIG. 1 in determining the position of the vehicle in step 210. In other embodiments, the processor 130 of FIG. 1 may obtain information as to the position of the vehicle from the vehicle itself or from a call center that is in communication with the vehicle, for example via a global positioning system (GPS) device and/or a wireless network. In certain other embodiments, additional information (such as photographic, radar, and/or lydar information) may also be utilized for the determination of step 212.

If it is determined in step 212 that the vehicle is not in proximity to the automated device, then the process returns to step 210, as the check for vehicle movement continues. Steps 210 and 212 repeat in this manner until there is a determination in an iteration of step 212 that a vehicle is in proximity to the automated device. Once there is a determination in any iteration of step 212 that a vehicle is in proximity to the automated device, the process proceeds to step 214, described directly below.

During step 214, the automated device begins to assist positioning of the vehicle. Preferably, during step 214, an audio or visual indication is provided for a driver of the vehicle to indicate where the vehicle should be parked. The indication may include, by way of example only, a flashing light or verbal command instructing the driver as to how close the driver should park the vehicle in proximity to the automated device. The indication is preferably provided by one or more of the indicators 150 of FIG. 1 via instructions provided thereto by the processor 130 of FIG. 1.

A determination is made as to whether the vehicle is in a proper position for charging of an energy storage system thereof (step 216). The energy storage system preferably corresponds to the energy storage system 104 of FIG. 1. During step 216, the processor 130 of FIG. 1 preferably utilizes the information obtained from the sensors 120 of FIG. 1 to determine whether the vehicle is close enough to the automated device such that the automated device can effectively connect to the vehicle to charge the energy storage system thereof.

If it is determined in step 216 that the vehicle is not in a proper position for charging, then the process returns to step 214. Steps 214 and 216 then repeat, as the automated device continues to provide assistance (such as audio and/or visual cues or instructions provided by the indicators 150 of FIG. 1 in accordance with instructions provided by the processor 130 of FIG. 1) until a determination is made in an iteration of step 216 that the car is in a proper position for charging or a timeout has occurred. Once a determination is made in an iteration of step 216 that the car is in a proper position for charging, a redundant check is conducted as to whether the vehicle is in proper position for charging (step 218). The redundant check of step 218 is preferably conducted by the processor 130 of FIG. 1.

If it is confirmed in step 218 that the vehicle is in a proper position for charging or a timeout has occurred, then the process proceeds to step 226, described further below. Conversely, if it is determined in step 218 that the vehicle is not (or is no longer) in a proper position for charging, then the process proceeds to step 220, described directly below.

During step 220, a determination is made as to whether the process has timed out. The determination is preferably made by the processor 130 of FIG. 1. If it is determined in step 220 that the process has not timed out, then the process returns to step 204, as the automated device is moved to its standby position, and the process continues from step 204.

Conversely, if it is determined in step 220 that the process has timed out, the process proceeds instead to step 222, in which an indication is provided that there is an issue with the vehicle charging. During step 222, a visual and/or audio indicator is preferably provided by one or more indicators 150 of FIG. 1 in accordance with instructions provided by the processor 130 of FIG. 1, indicating to a driver of the vehicle that there is a potential problem with the charging of the vehicle and/or with the automated system. In addition, the processor 130 of FIG. 1 attempts to diagnose, solve, and report the potential problem as may be appropriate (step 224). The process then returns to step 204, as the automated device is moved to its standby position, and the process continues beginning with step 204.

Returning now to step 218, if it is confirmed that the vehicle is in a proper position for charging, the process proceeds to step 226. During step 226, a determination is made as to whether a charge is requested for an energy storage system of the vehicle. Specifically, during step 226, a determination is made as to whether a charging of the energy storage system 104 of the vehicle 102 of FIG. 1 is desired or requested. In a preferred embodiment, the processor 130 of FIG. 1 receives information from the controller 112 of FIG. 1 as to whether the vehicle 102 is requesting that charging be conducted for the energy storage system 104 of FIG. 1. This information may be received by the processor 130 of FIG. 1 via the communication device 114 and/or the interface 134 of FIG. 1, such as via a wireless network. In certain embodiments, the request could also be represented by the presence of the vehicle, in which case the automatic charging system may be responsible for making the plug in process and therefore the connection (in such cases, the conductive connection might or might not automatically trigger the start of the charging current to the vehicle which can be decided by the energy storage system on vehicle). In either case, if a determination is made in step 226 that a charge is requested, then the process proceeds to step 230, described further below.

If it is determined in step 226 that a charge is not requested, then a determination is made as to whether the vehicle has been moved (step 228). This determination is preferably made by the processor 130 of FIG. 1 based on one or more measurements from the sensors 120 of FIG. 1 as to any new movement of the vehicle. If it is determined in step 228 that the vehicle has not been moved, then the process returns to step 226, and steps 226 and 228 thereafter repeat until there is a determination in an iteration of step 226 that a charge has been requested or in step 228 that the vehicle has moved. If a determination is made in any iteration of step 228 that the vehicle has moved, then the process returns to step 204, as the automated device is moved to its standby position, and the process proceeds from step 204.

Once a determination is made in any iteration of step 226 that a charge is requested for the vehicle energy storage system, a receptacle door is opened for the vehicle (step 230). Specifically, a receptacle door surrounding a charging receptacle of the vehicle is opened by the automated device that is external to the vehicle. In a preferred embodiment, the processor 130 of FIG. 1 directs one or more of the arms 124 and/or effectors 125 of FIG. 1 to open the receptacle door 110 of the vehicle 102 of FIG. 1.

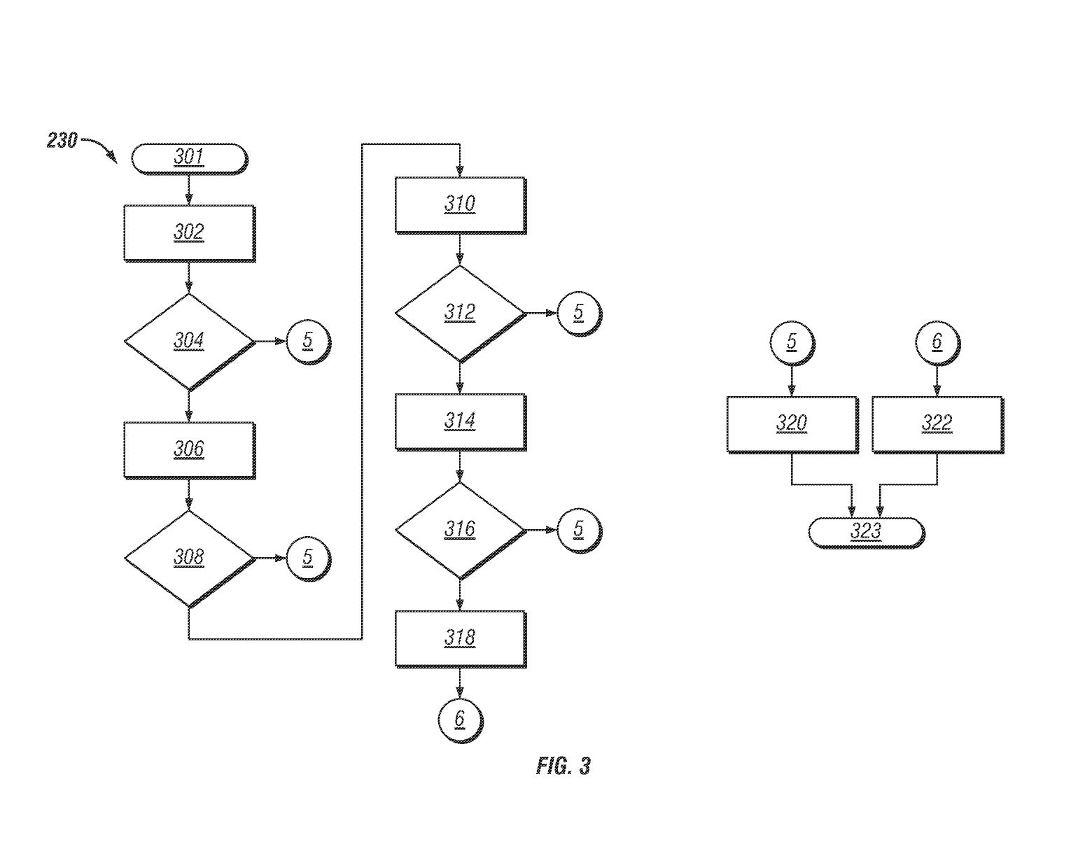

With reference to FIG. 3, a flowchart is provided for a sub-process for step 230 of the process 200 of FIG. 2, namely, the sub-process of opening the receptacle door, in accordance with an exemplary embodiment. As depicted in FIG. 3, once the sub-process for step 230 is initiated (step 301), the receptacle door is located (step 302). Specifically, the automated system 100 of FIG. 1 locates the receptacle door 110 of FIG. 1. In a preferred embodiment, the processor 130 of FIG. 1 directs one or more of the arms 124, effectors 125, and/or sensors 120 of FIG. 1 to locate the receptacle door 110 of FIG. 1. In one such embodiment, pattern recognition technology is utilized to locate the receptacle door using a camera. In other embodiments, photographic, radar, and/or lydar technology may be utilized.

A determination is then made as to whether the location of the receptacle door in step 302 was successful (step 304). This determination is preferably made by the processor 130 of FIG. 1. If it is determined that the location of the receptacle door was not successful, the process proceeds to step 320, described further below. Conversely, if it is determined that the location of the receptacle door was successful, the process proceeds instead to step 306, described directly below.

During step 306, the automated device is moved close to the receptacle door. Specifically, in one embodiment, the processor 130 of FIG. 1 moves the automated system 100 of FIG. 1 in its entirety toward the receptacle door 110 FIG. 1. In an alternate embodiment, the processor 130 of FIG. 1 directs one or more of the arms 124 of FIG. 1 to move toward the receptacle door 110 of FIG. 1. When the automated device moves (and/or the arms 124 and/or other components thereof move), such as in step 306 as well as in certain other steps described further herein, the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 306 (as well as certain other steps described herein that also pertain to movement of the automated device) comply with the steps of the process 700 that are depicted in FIG. 7 and described in greater detail further below in connection therewith.

A determination is then made as to whether the movement of the automated device toward the charging receptacle was successful (step 308). This determination is preferably made by the processor 130 of FIG. 1. If it is determined that the movement of the automated device toward the charging receptacle was not successful, the process proceeds to step 320, described further below. Conversely, if it is determined that the movement of the automated device toward the charging receptacle was successful, the process proceeds instead to step 310, described directly below.

During step 310, an effector is selected for opening the receptacle door. Specifically, an effector 125 of one or more of the arms 124 of FIG. 1 is selected by the processor 130 for opening the receptacle door 110 of FIG. 1.

A determination is then made as to whether the selection of the effector was successful (step 312). This determination is preferably made by the processor 130 of FIG. 1. If it is determined that the selection of the effector was not successful, the process proceeds to step 320, described further below. Conversely, if it is determined that the selection of the effector was successful, the process proceeds instead to step 314, described directly below.

During step 314, the receptacle door is opened. In one embodiment, the processor 130 of FIG. 1 directs one of the arms 124 of FIG. 1 (and an effector 125 thereof) to open the receptacle door 110 of FIG. 1. When the automated device moves, such as in step 314 as well as in certain other steps described herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 314 (as well as certain other steps described herein that also pertain to movement of the automated device) comply with the steps of the process 700 that are depicted in FIG. 7 and described in greater detail further below in connection therewith.

A determination is then made as to whether the opening of the receptacle door was successful (step 316). This determination is preferably made by the processor 130 of FIG. 1. If it is determined that the opening of the receptacle door was not successful, the process proceeds to step 320, described further below. Conversely, if it is determined that the opening of the receptacle door was successful, the process proceeds instead to step 318, described directly below.

During step 318, the automated device is positioned to prepare for inserting a charging plug into the charging receptacle. In one preferred embodiment, the processor 130 of FIG. 1 directs the positioning of one or more of the arms 124 of FIG. 1, including one or more effectors 125 thereof, for insertion of the charging plug 128 of FIG. 1 into the charging receptacle 108 of FIG. 1.

Following the positioning of step 318, a determination is made that the opening of the receptacle door has been successful (step 322). This determination is preferably made by the processor 130 of FIG. 1. In addition, an open receptacle door success flag is set equal to one by the processor 130 of FIG. 1 and is stored in the memory 132 as one of the stored values 142 thereof for subsequent retrieval and processing by the processor 130 of FIG. 1.

Conversely, as referenced above, if any of the determinations of steps 304, 308, 312, or 316 indicate an unsuccessful attempt, then the process proceeds instead to step 320. During step 320, a determination is made that the opening of the receptacle door has not been successful. This determination is preferably made by the processor 130 of FIG. 1. In addition, an open receptacle door success flag is set equal to zero by the processor 130 of FIG. 1 and is stored in the memory 132 as one of the stored values 142 thereof for subsequent retrieval and processing by the processor 130 of FIG. 1. Following either of steps 320 or 321, the sub-process terminates (step 323), and the process returns to FIG. 2.

Returning now to FIG. 2, a determination is made as to whether the receptacle door has been opened successfully (step 232). Preferably, during step 232, the open receptacle door success flag is retrieved by the processor 130 of FIG. 1 from the memory 132 of FIG. 1. If the receptacle door has not been opened successfully, the process proceeds to step 222, described above. Conversely, if the receptacle door has been opened successfully, then the process proceeds instead to step 234, described directly below.

During step 234, the charging plug is inserted into the charging receptacle. In one embodiment, the processor 130 of FIG. 1 directs one of the arms 124 of FIG. 1 (including one of the effectors 125 thereof) to insert the charging plug 128 of FIG. 1 into the charging receptacle 108 of FIG. 1 to charge the energy storage system 104 of FIG. 1.

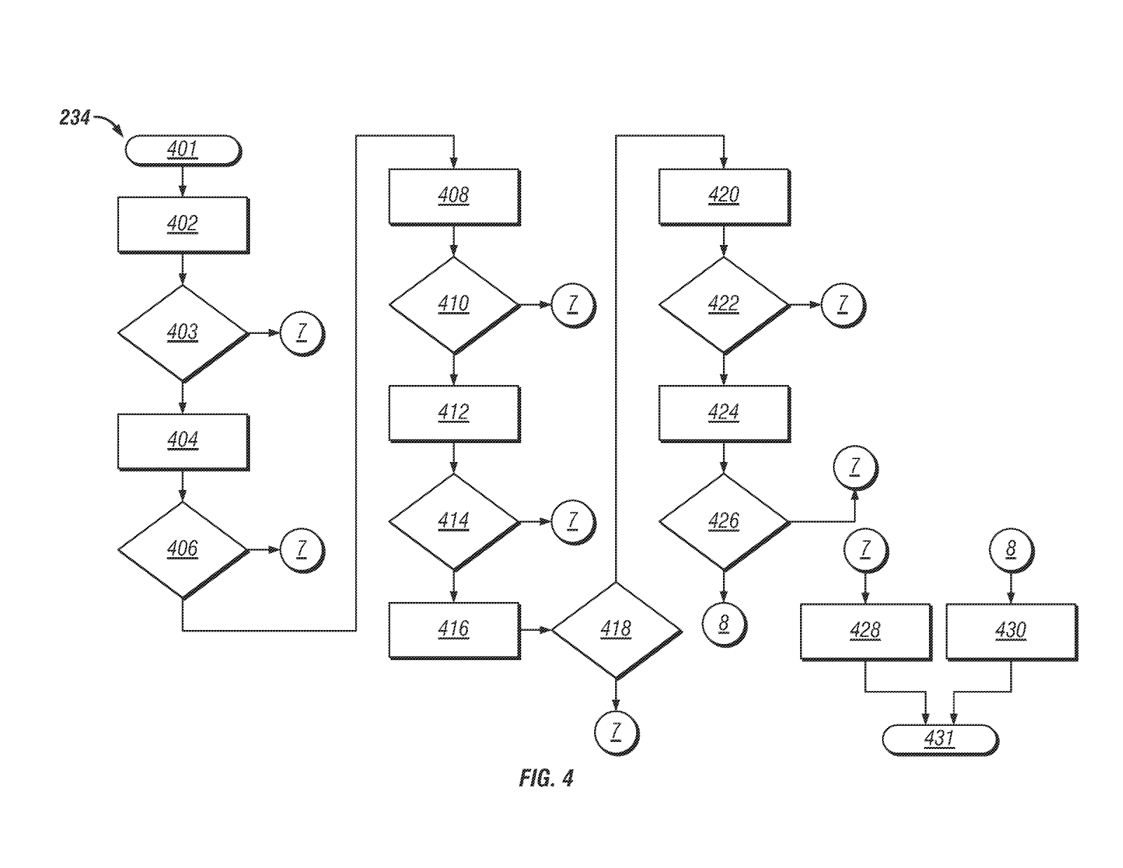

With reference to FIG. 4, a flowchart is provided for a sub-process for step 234 of the process 200 of FIG. 2, namely, the sub-process of inserting the charging plug into the charging receptacle, in accordance with an exemplary embodiment. As depicted in FIG. 4, once the sub-process 234 is initiated (step 401), the receptacle is located (step 402). Specifically, the automated system 100 of FIG. 1 locates the charging receptacle 108 of FIG. 1. In a preferred embodiment, the processor 130 of FIG. 1 directs one or more of the arms 124, effectors 125, and/or sensors 120 of FIG. 1 to locate the charging receptacle 108 of FIG. 1. In one such embodiment, pattern recognition technology is utilized by the sensors 120, the arms 124, the effectors 125, and/or the processor 130 of FIG. 1 to locate the receptacle. In other embodiments, photographic, radar, and/or lydar technology may be utilized, for example by the sensors 120, the arms 124, the effectors 125, and/or the processor 130 of FIG. 1.

A determination is then made as to whether the location of the receptacle was successful (step 403). This determination is preferably made by the processor 130 of FIG. 1. If it is determined that the location of the receptacle was not successful, the process proceeds to step 428, described further below. Conversely, if it is determined that the location of the receptacle was successful, the process proceeds instead to step 404, described directly below.

During step 404, an effector is selected for inserting the charging plug into the charging receptacle. Specifically, an effector 125 of one or more of the arms 124 of FIG. 1 is selected by the processor 130 for inserting the charging plug 128 of FIG. 1 into the charging receptacle 108 of FIG. 1.

A determination is then made as to whether the selection of the effector was successful (step 406). This determination is preferably made by the processor 130 of FIG. 1. If it is determined that the selection of the effector was not successful, the process proceeds to step 428, described further below. Conversely, if it is determined that the selection of the effector was successful, the process proceeds instead to step 408, described directly below.

During step 408, the effector is moved close to the receptacle. Specifically, in one embodiment, the processor 130 of FIG. 1 moves one of the effectors 125 of one of the arms 124 of FIG. 1 toward the charging receptacle 108 of FIG. 1. When the effector moves, such as in step 408, the processor 130 preferably first ascertains a projected path or trajectory between the effector and the vehicle, determines whether any obstacles are in the path or trajectory, and directs movement of the effector in such a manner as to avoid contact with the obstacles. Preferably, these actions of step 408 comply with the steps of the process 700 that are depicted in FIG. 7 and described in greater detail further below in connection therewith.

A determination is then made as to whether the movement of the effector toward the charging receptacle was successful (step 410). This determination is preferably made by the processor 130 of FIG. 1. If it is determined that the movement of the effector toward the charging receptacle was not successful, the process proceeds to step 428, described further below. Conversely, if it is determined that the movement of the effector toward the charging receptacle was successful, the process proceeds instead to step 412, described directly below.

During step 412, the receptacle is located again. In a preferred embodiment, the receptacle is located in step 412 in a manner that is similar to that of step 402, described above. A determination is then made as to whether the location of step 412 was successful (step 414). This determination is preferably made by the processor 130 of FIG. 1. If it is determined that the location of step 412 was not successful, the process proceeds to step 428, described further below. Conversely, if it is determined that the location of step 412 was successful, the process proceeds instead to step 416, described directly below.

During step 416, the automated device begins to insert the charging plug into the receptacle. In one embodiment, the processor 130 of FIG. 1 directs one of the arms 124 of FIG. 1 (and an effector 125 thereof) to insert the charging plug 128 into the charging receptacle 108 of FIG. 1. When the automated device moves, such as in step 416 as well as in certain other steps described herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 416 (as well as certain other steps described herein that also pertain to movement of the automated device) comply with the steps of the process 700 that are depicted in FIG. 7 and described in greater detail further below in connection therewith.

A determination is then made as to whether the beginning of the insertion of the charging plug into the charging receptacle was successful (step 418). This determination is preferably made by the processor 130 of FIG. 1. If it is determined that the beginning of the insertion of the charging plug into the charging receptacle was not successful, the process proceeds to step 428, described further below. Conversely, if it is determined that the beginning of the insertion of the charging plug into the charging receptacle was successful, the process proceeds instead to step 420, described directly below.

During step 420, the automated device continues to insert the charging plug into the receptacle. In one embodiment, the processor 130 of FIG. 1 directs one of the arms 124 of FIG. 1 (and an effector 125 thereof) to further insert the charging plug 128 into the charging receptacle 108 of FIG. 1. When the automated device moves, such as in step 420 (as well as in certain other steps described herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 420 (as well as certain other steps described herein that also pertain to movement of the automated device) comply with the steps of the process 700 that are depicted in FIG. 7 and described in greater detail further below in connection therewith.

A determination is then made as to whether the continuing insertion of the charging plug into the charging receptacle was successful (step 422). This determination is preferably made by the processor 130 of FIG. 1. If it is determined that the continuing insertion of the charging plug into the charging receptacle was not successful, the process proceeds to step 428, described further below. Conversely, if it is determined that the continuing insertion of the charging plug into the charging receptacle was successful, the process proceeds instead to step 424, described directly below.

During step 424, the automated device confirms that there is a valid connection between the charging cord and the charging receptacle. In one embodiment, the processor 130 of FIG. 1 confirms that there is a valid connection between the charging plug 128 of FIG. 1 and the charging receptacle 108 of FIG. 1.

A determination is then made as to whether the confirmation of the connection was successful (step 426). This determination is preferably made by the processor 130 of FIG. 1. If it is determined that the confirmation of the connection was not successful, the process proceeds to step 428, described further below. Conversely, if it is determined that the confirmation of the connection was successful, the process proceeds instead to step 430, described directly below.

During step 430, a determination is made that the insertion of the charging plug into the charging receptacle has been successful. This determination is preferably made by the processor 130 of FIG. 1. In addition, a charging plug insertion success flag is set equal to one by the processor 130 of FIG. 1 and is stored in the memory 132 as one of the stored values 142 thereof for subsequent retrieval and processing by the processor 130 of FIG. 1.

Conversely, as referenced above, if any of the determinations of steps 403, 406, 410, 414, 418, 422, or 426 indicate an unsuccessful attempt, then the process proceeds instead to step 428. During step 428, a determination is made that the charging plug insertion has not been successful. This determination is preferably made by the processor 130 of FIG. 1. In addition, a charging plug insertion success flag is set equal to zero by the processor 130 of FIG. 1 and is stored in the memory 132 as one of the stored values 142 thereof for subsequent retrieval and processing by the processor 130 of FIG. 1. Following either of steps 428 or 430, the sub-process terminates (step 431), and the process returns to FIG. 2.

Returning now to FIG. 2, a determination is made as to whether the charging plug was successfully inserted into the charging receptacle (step 236). Preferably, during step 236, the charging plug insertion success flag is retrieved by the processor 130 of FIG. 1 from the memory 132 of FIG. 1. If the charging plug has not been successfully inserted into the charging receptacle, then the process proceeds to step 222, described above. Conversely, if the charging plug has been successfully inserted into the charging receptacle, then the process proceeds instead to step 238, described directly below.

During step 238, the energy storage system is charged. Specifically, the energy storage system 104 of FIG. 1 is charged by the automated system 100 of FIG. 1 via the charging plug 128 of FIG. 1 while the charging plug 128 remains plugged into the charging receptacle 108 of FIG. 1. In a preferred embodiment, the charging continues until the charging is complete or until a disconnect signal is received, whichever comes first. Upon completion of the charge, the charging stops, but the charging plug 128 of FIG. 1 preferably remains connected and plugged into the charging receptacle 108 of FIG. 1 until the processor 130 of FIG. 1 receives information from the controller 112 of FIG. 1 representing a disconnect command requesting that the charging plug 128 of FIG. 1 be removed, unplugged, and/or disconnected form the charging receptacle 108 of FIG. 1.

A determination is made as to whether such a disconnect command is received from the vehicle (step 240). In one embodiment, a disconnect command is provided by the controller 112 of FIG. 1 to the processor 130 of FIG. 1 when the driver is approaching the vehicle, and/or when the controller 112 otherwise determines that the driver is about to activate or turn on the vehicle (for example, if a current day of the week and time of day corresponds to a typical day and time in which the driver drives the vehicle to work, or the like). In an alternate embodiment, a disconnect command may be provided by the controller 112 of FIG. 1 to the processor 130 of FIG. 1 when the energy storage system 104 of FIG. 1 is fully charged, for example if there is no need for the charging plug 128 of FIG. 1 to remain connected and plugged into the charging receptacle 108 of FIG. 1 after charging is complete. This determination is preferably made by the processor 130 of FIG. 1 based on information provided thereto by the controller 112 of FIG. 1.

If it is determined that a disconnect command has not yet been received, then the process returns to step 238. Steps 238 and 240 repeat in various iterations until a determination is made in an iteration of step 240 that a disconnect command is received.

Once a determination is made in an iteration of step 240 that a disconnect command is received, the charging cord is unplugged and removed from the charging receptacle (step 242). Specifically, in one preferred embodiment, during step 242, the processor 130 of FIG. 1 directs one of the arms 124 of FIG. 1 (including one of the effectors 125 thereof) to unplug and disconnect the charging plug 128 of FIG. 1 from the charging receptacle 108 of FIG. 1.

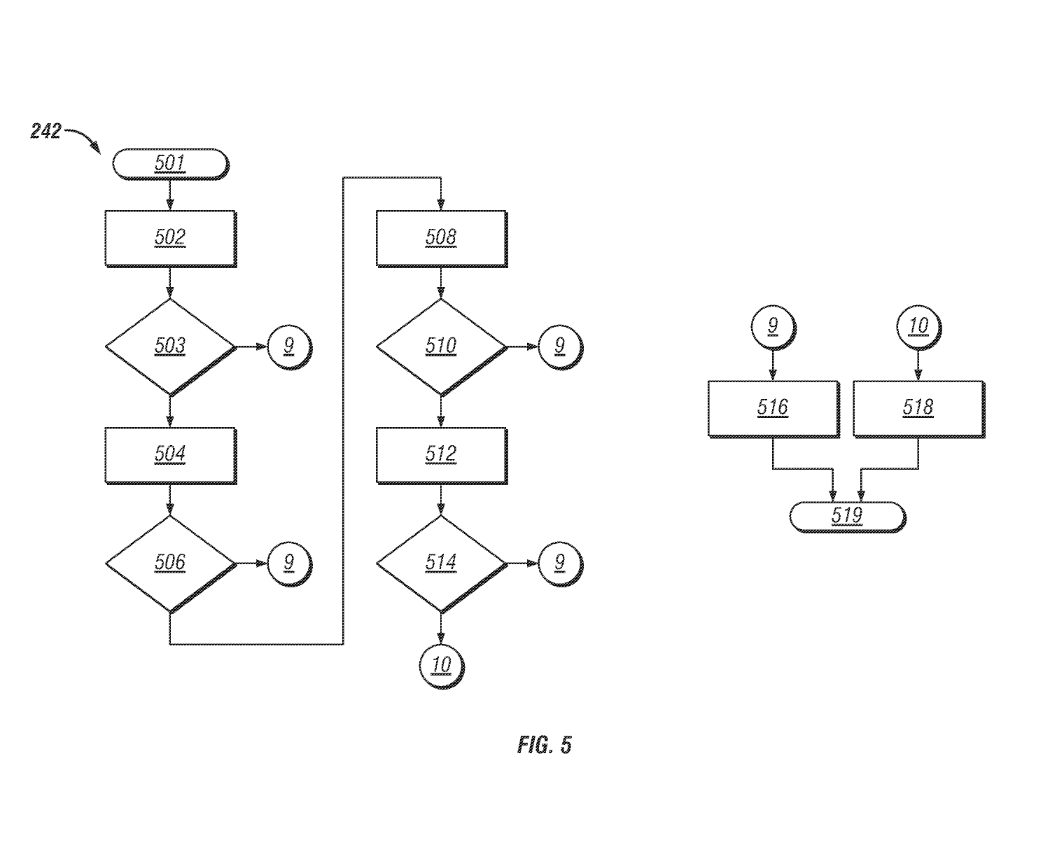

With reference to FIG. 5, a flowchart is provided for a sub-process for step 242 of the process 200 of FIG. 2, namely, the sub-process of unplugging the charging plug from the charging receptacle, in accordance with an exemplary embodiment. As depicted in FIG. 5, once the sub-process 242 is initiated (step 501), an unplug event is coordinated between the automated device and the vehicle (step 502). Preferably, during step 502, the unplug event is coordinated between the processor 130 and the controller 112 of FIG. 1.

A determination is then made as to whether the coordination of step 502 was successful (step 503). This determination is preferably made by the processor 130 of FIG. 1. If it is determined that the coordination was not successful, the process proceeds to step 516, described further below. Conversely, if it is determined that the coordination was successful, the process proceeds instead to step 504, described directly below.

During step 504, the automated device disconnects, unplugs, and removes the charging cord from the charging receptacle. In one embodiment, the processor 130 of FIG. 1 directs one of the arms 124 of FIG. 1 (and an effector 125 thereof) to disconnect, unplug, and remove the charging plug 128 from the charging receptacle 108 of FIG. 1. When the automated device moves, such as in step 504 (as well as in certain other steps described herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 504 (as well as certain other steps described herein that also pertain to movement of the automated device) comply with the steps of the process 700 that are depicted in FIG. 7 and described in greater detail further below in connection therewith.

A determination is then made as to whether the removal of the charging plug from the charging receptacle was successful (step 506). This determination is preferably made by the processor 130 of FIG. 1. If it is determined that the removal of the charging plug from the charging receptacle was not successful, the process proceeds to step 516, described further below. Conversely, if it is determined that the removal of the charging plug from the charging receptacle was successful, the process proceeds instead to step 508, described directly below.

During step 508, a confirmation is conducted pertaining to the removal (or, disconnection, or unplugging) of the charging plug from the charging receptacle of step 504. A determination is then made as to whether the removal of the charging cord from the charging receptacle was successful (step 510). This confirmation and determination are preferably made by the processor 130 of FIG. 1. If the removal of the charging cord from the charging receptacle was not successful, the process proceeds to step 516, described further below. Conversely, if the removal of the charging cord from the charging receptacle was successful, the process proceeds to step 512, described directly below.

During step 512, the automated device is moved into position to be ready to close the receptacle door. In one embodiment, the processor 130 of FIG. 1 directs one of the arms 124 of FIG. 1 (and an effector 125 thereof) to move close to the receptacle door 110 of FIG. 1.

A determination is then made as to whether the movement of step 512 was successful (step 514). This determination is preferably made by the processor 130 of FIG. 1. If the movement of step 512 was unsuccessful, the process proceeds to step 516, described further below. Conversely, if the movement of step 512 was successful, the process proceeds to step 518, described directly below.

During step 518, a determination is made that the charging plug has been successfully disconnected, unplugged, and removed from the charging receptacle. This determination is preferably made by the processor 130 of FIG. 1. In addition, a charging plug removal success flag is set equal to one by the processor 130 of FIG. 1 and is stored in the memory 132 as one of the stored values 142 thereof for subsequent retrieval and processing by the processor 130 of FIG. 1.

Conversely, as referenced above, if any of the determinations of steps 503, 506, 510, or 514 indicate an unsuccessful attempt, then the process proceeds instead to step 516. During step 516, a determination is made that the charging plug removal has not been successful. This determination is preferably made by the processor 130 of FIG. 1. In addition, a charging plug removal success flag is set equal to zero by the processor 130 of FIG. 1 and is stored in the memory 132 as one of the stored values 142 thereof for subsequent retrieval and processing by the processor 130 of FIG. 1. Following either of steps 516 or 518, the sub-process terminates (step 519), and the process returns to FIG. 2.

Returning now to FIG. 2, a determination is made as to whether the removal (or disconnecting or unplugging) of the charging plug from the charging receptacle was successful (step 244). Preferably, during step 244, the charging plug removal success flag is retrieved by the processor 130 of FIG. 1 from the memory 132 of FIG. 1. If the charging plug has not been successfully removed from the charging receptacle, then the process proceeds to step 222, described above. Conversely, if the charging plug has been successfully unplugged and removed from the charging receptacle, then the process proceeds instead to step 246, described directly below.

During step 246, the receptacle door is closed by the automated device. In one embodiment, the processor 130 of FIG. 1 directs one of the arms 124 of FIG. 1 (and, specifically, one of the effectors 125 thereof) to close the receptacle door 110 of FIG. 1.

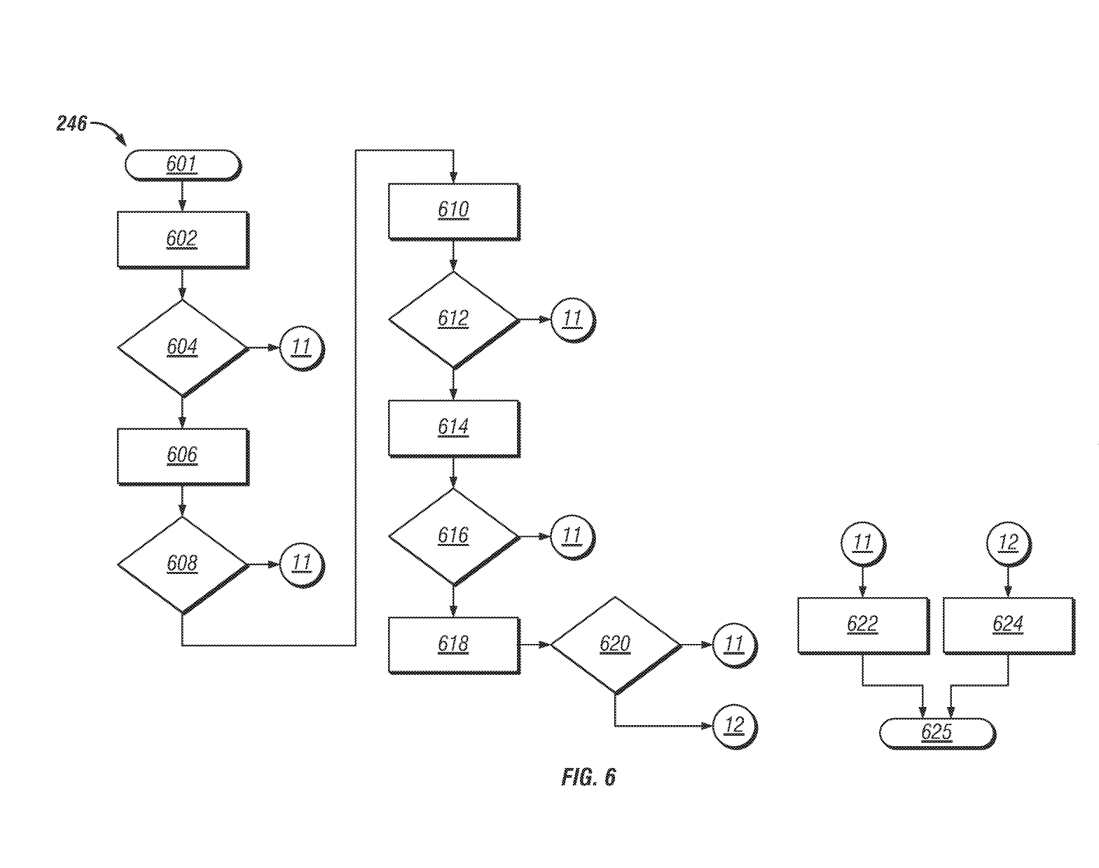

With reference to FIG. 6, a flowchart is provided for a sub-process for step 246 of the process 200 of FIG. 2, namely, the sub-process of closing the receptacle door. As depicted in FIG. 6, once the sub-process for step 246 is initiated (step 601), the receptacle door is located (step 602). Specifically, the automated system 100 of FIG. 1 locates the charging receptacle 108 of FIG. 1. In a preferred embodiment, the processor 130 of FIG. 1 directs one or more of the arms 124, effectors 125, and/or sensors 120 of FIG. 1 to locate the charging receptacle 108 of FIG. 1. In one such embodiment, pattern recognition technology is utilized by the sensors 120, the arms 124, the effectors 125, and/or the processor 130 of FIG. 1 to locate the receptacle door 110 of FIG. 1. In other embodiments, photographic, radar, and/or lydar technology may be utilized, for example by the sensors 120, the arms 124, the effectors 125, and/or the processor 130 of FIG. 1.

A determination is then made as to whether the location of the receptacle door was successful (step 604). This determination is preferably made by the processor 130 of FIG. 1. If it is determined that the location of the receptacle door was not successful, the process proceeds to step 622, described further below. Conversely, if it is determined that the location of the receptacle door was successful, the process proceeds instead to step 606, described directly below.

During step 606, the automated device is moved close to the receptacle door. Specifically, in one embodiment, the processor 130 of FIG. 1 moves the automated system 100 of FIG. 1 in its entirety toward the receptacle door 110 FIG. 1. In an alternate embodiment, the processor 130 of FIG. 1 directs one or more of the arms 124 of FIG. 1 to move toward the receptacle door 110 of FIG. 1. When the automated device moves (and/or the arms 124 and/or other components thereof move), such as in step 606 as well as in certain other steps described further herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 606 (as well as certain other steps described herein that also pertain to movement of the automated device) comply with the steps of the process 700 that are depicted in FIG. 7 and described in greater detail further below in connection therewith.

A determination is then made as to whether the movement of the automated device toward the charging receptacle was successful (step 608). This determination is preferably made by the processor 130 of FIG. 1. If it is determined that the movement of the automated device toward the charging receptacle was not successful, the process proceeds to step 622, described further below. Conversely, if it is determined that the movement of the automated device toward the charging receptacle was successful, the process proceeds instead to step 610. described directly below.

During step 610, an effector is selected for closing the receptacle door. Specifically, an effector 125 of one or more of the arms 124 of FIG. 1 is selected by the processor 130 for closing the receptacle door 110 of FIG. 1.

A determination is then made as to whether the selection of the effector was successful (step 612). This determination is preferably made by the processor 130 of FIG. 1. If it is determined that the selection of the effector was not successful, the process proceeds to step 622, described further below. Conversely, if it is determined that the selection of the effector was successful, the process proceeds instead to step 614, described directly below.

During step 614, the receptacle door is closed. In one embodiment, the processor 130 of FIG. 1 directs one of the arms 124 of FIG. 1 (and an effector 125 thereof) to close the receptacle door 110 of FIG. 1. When the automated device moves, such as in step 614 as well as in certain other steps described herein), the processor 130 preferably first ascertains a projected path or trajectory between the automated device and the vehicle, determines whether any obstacles are in the path or trajectory, and moves the automated device (or one or more components thereof) in such a manner as to avoid contact with the obstacles. Preferably, these actions of step 614 (as well as certain other steps described herein that also pertain to movement of the automated device) comply with the steps of the process 700 that are depicted in FIG. 7 and described in greater detail further below in connection therewith.

A determination is then made as to whether the closing of the receptacle door was successful (step 616). This determination is preferably made by the processor 130 of FIG. 1. If it is determined that the closing of the receptacle door was not successful, the process proceeds to step 622, described further below. Conversely, if it is determined that the closing of the receptacle door was successful, the process proceeds instead to step 618, described directly below.

During step 618, a confirmation is made as to whether the receptacle door has been closed. A determination is made, based on the confirmation, as to whether the receptacle door has been closed successfully (step 620). The confirmation and determination of steps 618 and 620 are preferably performed by the processor 130 of FIG. 1.

If it is determined in step 620 that the receptacle door has been closed successfully, then a formal determination is recorded, for further use in implementing the process 200, that the closing of the receptacle door has been successful (step 624). This determination is preferably made by the processor 130 of FIG. 1. In addition, a close receptacle door success flag is set equal to one by the processor 130 of FIG. 1 and is stored in the memory 132 as one of the stored values 142 thereof for subsequent retrieval and processing by the processor 130 of FIG. 1.

Conversely, as referenced above, if any of the determinations of steps 604, 608, 612, 616, or 620 indicate an unsuccessful attempt, then the process proceeds instead to step 622. During step 622, a determination is made that the closing of the receptacle door has not been successful. This determination is preferably made by the processor 130 of FIG. 1. In addition, a close receptacle door success flag is set equal to zero by the processor 130 of FIG. 1 and is stored in the memory 132 as one of the stored values 142 thereof for subsequent retrieval and processing by the processor 130 of FIG. 1. Following either of steps 622 or 624, the sub-process terminates (step 625), and the process returns to FIG. 2.

Returning now to FIG. 2, a determination is made as to whether the receptacle door has been closed successfully (step 248). Preferably, during step 248, the close receptacle door success flag is retrieved by the processor 130 of FIG. 1 from the memory 132 of FIG. 1. If the receptacle door has not been closed successfully, the process proceeds to step 222, described above. Conversely, if the receptacle door has been closed successfully, then the process proceeds instead to step 204, also described above.

FIG. 7 is a flowchart of a process 700 for moving an automated device used for charging an energy storage system of a vehicle, such as an electric or hybrid electric automobile, in accordance with an exemplary embodiment. Specifically, the process 700 is preferably utilized for movement of the automated system 100 of FIG. 1 and/or one or more components thereof (such as the arms 124 or the effectors 125 of FIG. 1), for example with respect to steps 204, 306, 314, 318, 408, 416, 420, 504, 512, 606, and 614 referenced above in connection with FIGS. 2-6 and the process 200.

As depicted in FIG. 7, once the process 700 is initiated (step 701), a target location is read (step 702). Specifically, the automated system 100 of FIG. 1 locates and reads a target position toward which it is desired to move the automated system 100 and/or one or more components (such as the arms 124 and/or effectors 125 of FIG. 1) thereof. In one embodiment, pattern recognition technology is utilized by the sensors 120 and the processor 130 of FIG. 1 to plan the path or trajectory. In other embodiments, photographic, radar, and/or lydar technology may be utilized, for example, by the sensors 120 and the processor 130 of FIG. 1. The path or trajectory is then planned utilizing this information (step 704), preferably via the processor 130 of FIG. 1.

A determination is then made as to whether the planning of the path or trajectory was successful (step 706). This determination is preferably made by the processor 130 of FIG. 1. If it is determined that the planning of the path or trajectory was not successful, the process proceeds to step 722, described further below. Conversely, if it is determined that the planning of the path or trajectory was successful, the process proceeds instead to step 708, described directly below.

During step 708, the path or trajectory is checked for obstacles. In one embodiment, the path or trajectory is checked for any obstacles that are currently within the path or trajectory. In another embodiment, the path or trajectory is checked for any obstacles that are headed toward, and/or that are likely to intersect with, the path or trajectory. In one embodiment, pattern recognition technology is utilized by the sensors 120 and the processor 130 of FIG. 1 to check for obstacles. In other embodiments, photographic, radar, and/or lydar technology may be utilized, for example by the by the sensors 120 and the processor 130 of FIG. 1.

A determination is then made, based on the findings of step 708, as to whether the path or trajectory is clear of obstacles (step 710). This determination is preferably made by the processor 130 of FIG. 1. If it is determined that the path or trajectory is clear of obstacles, then the process proceeds to step 714, described further below.

Conversely, if it is determined that the path or trajectory is not clear of obstacles, then an indication or warning is provided (step 711). Specifically, the processor 130 of FIG. 1 directs one or more of the indicators 150 of FIG. 1 to provide audio and/or visual warnings for any nearby individuals. In addition, a determination is made as to whether the process has timed out (step 712). This determination is preferably made by the processor 130 of FIG. 1.

If it is determined that the process has timed out, then the process proceeds to step 722, described further below. Conversely, if it is determined that the process has not timed out, then the process proceeds instead to step 708. Steps 708-712 then repeat until a determination is made in an iteration of step 710 that the path or trajectory is clear of obstacles (at which point the process proceeds to step 714) or until a determination is made in an iteration of step 712 that the process has timed out (at which point the process proceeds to step 722).

Once a determination is made that the path or trajectory is clear of obstacles, the automated device (and/or one or more components thereof, such as an arm 124 and/or an effector 125 of FIG. 1) are moved incrementally toward the target (step 714). This movement is preferably directed by the processor 130 of FIG. 1. A determination is then made as to whether the incremental movement has been successful (step 716). This determination is preferably made by the processor 130 of FIG. 1.

If it is determined in step 716 that the incremental movement toward the target has not been successful (for example, that the automated device and/or components thereof are not successfully moving toward the intended target), then a determination is made as to whether a maximum number of attempts to move the automated device (and/or certain components thereof) toward the target has been exceeded (step 720). This determination is preferably made by the processor 130 of FIG. 1. If the maximum number of attempts has been exceeded, then the process proceeds to step 722, described further below. If the maximum number of attempts has not been exceeded, the process proceeds instead to step 704, described above.

Conversely, if it is determined in step 716 that the incremental movement toward the target has been successful, a determination is also made as to whether the automated device has (and/or the components thereof that are intended to reach the target have) reached the target (step 718). This determination is preferably made by the processor 130 of FIG. 1. If it is determined that the automated device (and/or the components thereof that are intended to reach the target) have not reached the target, the process proceeds to step 708, described above. Conversely, if it is determined that the automated device (and/or the components thereof that are intended to reach the target) have reached the target, then the process proceeds instead to step 724, described directly below.

During step 724, a determination is made that the automated device (and/or the components thereof that are intended to reach the target) have successfully reached the target. This determination is preferably made by the processor 130 of FIG. 1. In addition, a target reached success flag is set equal to one by the processor 130 of FIG. 1 and is stored in the memory 132 as one of the stored values 142 thereof for subsequent retrieval and processing by the processor 130 of FIG. 1.

Conversely, as referenced above, if any of the determinations of steps 706, 712, or 720 indicate an unsuccessful attempt, then the process proceeds instead to step 722. During step 722, a determination is made that the automated device (and/or the components thereof that are intended to reach the target) have not successfully reached the target. This determination is preferably made by the processor 130 of FIG. 1. In addition, a target reached success flag is set equal to zero by the processor 130 of FIG. 1 and is stored in the memory 132 as one of the stored values 142 thereof for subsequent retrieval and processing by the processor 130 of FIG. 1. Following either of steps 722 or 724, the process terminates (step 725).

Accordingly, improved methods, program products, and systems are provided for automated charging of energy storage systems for vehicles. It will be appreciated that the disclosed methods and systems may vary from those depicted in the Figures and described herein. For example, it will be appreciated that certain components of the automated system 100 of FIG. 1 may vary. It will similarly be appreciated that certain steps of the processes 200, 700 (and/or sub-processes thereof) may vary from those depicted in FIGS. 2-7 and/or described above in connection therewith, and/or may be may occur simultaneously or in a different order than that depicted in FIGS. 2-7 and/or described above in connection therewith. It will similarly be appreciated that the disclosed methods and systems may be implemented and/or utilized in connection with any number of different types of automobiles, sedans, sport utility vehicles, trucks, any of a number of other different types of vehicles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method for charging an energy storage system of a vehicle, the method comprising the steps of:
obtaining a position of the vehicle;
locating a charging receptacle of the vehicle based on the position; and
guiding an arm to insert a charging device into the charging receptacle via a processor.

2. The method of claim 1, further comprising the step of:
initiating a charge if the energy storage system requires charging.

3. The method of claim 1, further comprising the step of:
detecting a movement of the vehicle for use in obtaining the position, wherein the position is obtained based at least in part on the movement.

4. The method of claim 1, further comprising the steps of:
determining a path for the arm toward the charging receptacle;
determining whether an obstacle is within the path; and
providing a notification if the obstacle is within the path.

5. The method of claim 1, further comprising the step of
receiving information from the vehicle as to whether the energy storage system requires charging, wherein the step of guiding the arm comprises the step of guiding the arm to insert the charging device into the charging receptacle only on a further condition that the information indicates that the energy storage system requires charging.

6. The method of claim 1, wherein the charging receptacle is surrounded by a receptacle door, and the method further comprises the step of:
guiding the arm to open the receptacle door via the processor.

7. The method of claim 6, further comprising the steps of:
receiving a disconnect command from the vehicle; and
guiding the arm to remove the charging device from the receptacle and close the receptacle door once the disconnect command is received via the processor.

8. A program product for charging an energy storage system of a vehicle, the program product comprising:
a program configured to:
obtain a position of the vehicle;
locate a charging receptacle of the vehicle based on the position; and
guide an arm to insert a charging device into the charging receptacle; and
a non-transitory, computer-readable storage medium storing the program.

9. The program product of claim 8, wherein the program is further configured to initiate a charge if the energy storage system requires charging.

10. The program product of claim 8, wherein the program is further configured to:
determine a path for the arm toward the charging receptacle;
determine whether an obstacle is within the path; and
provide a notification if the obstacle is within the path.

11. The program product of claim 8, wherein the program is further configured to:
receive information from the vehicle as to whether the energy storage system requires charging; and
guide the arm to insert the charging device into the charging receptacle only on a further condition that the information indicates that the energy storage system requires charging.

12. The program product of claim 8, wherein the charging receptacle is surrounded by a receptacle door, and the program is further configured to guide the arm to open the receptacle door.

13. The program product of claim 12, wherein the program is further configured to:
receive a disconnect command from the vehicle; and
guide the arm to remove the charging device from the receptacle and close the receptacle door once the disconnect command is received.

14. An automated system for charging an energy storage system of a vehicle, the automated system comprising:
an arm; and
a processor coupled to the arm and configured to:
obtain a position of the vehicle; and
guide the arm to:
locate a charging receptacle of the vehicle based on the position; and
insert the charging device into the charging receptacle.

15. The automated system of claim 14, wherein the processor is further configured to initiate a charge if the energy storage system requires charging.

16. The automated system of claim 14, further comprising:
a sensor coupled to the processor and configured to detect movement of the vehicle for use by the processor in obtaining the position.

17. The automated system of claim 14, further comprising:
a notification device;
wherein the processor is further configured to:
determine a path for the arm toward the charging receptacle;
determine whether an obstacle is within the path; and
direct the notification device to provide a notification if the obstacle is within the path.

18. The automated device of claim 14, wherein the processor is further configured to:
receive information from the vehicle as to whether the energy storage system requires charging; and
guide the arm to insert the charging device into the charging receptacle only on a further condition that the information indicates that the energy storage system requires charging.

19. The automated device of claim 14, wherein the charging receptacle is surrounded by a receptacle door, and the processor is further configured to guide the arm to open the receptacle door.

20. The automated device of claim 19, wherein the processor is further configured to:
receive a disconnect command from the vehicle; and
guide the arm to remove the charging device from the receptacle and close the receptacle door once the disconnect command is received.
